(19) United States
(12) Patent Application Publication
(10) Pub. No.: US 2003/0093805 A1
(43) Pub. Date: May 15, 2003

(54) Dual camera surveillance and control system

(76) Inventor: J.M. Jack Gin, Burnaby (CA)

Correspondence Address: Paul D. Gornall, Barrister & Solicitor; Reg'd Patent & TM Agent, 1820-355 Burrard St., Vancouver, BC, V6C 2G8, CA

(21) Appl. No.: 09/987,498

(22) Filed: Nov. 15, 2001

(51) Int. Cl. H04N 7/18

(52) U.S. Cl. 725/105; 348/143; 348/162; 348/164

(57) ABSTRACT

The present invention provides a dual camera surveillance and control system. The system comprises a high sensitivity mono camera with enhanced infrared response, an infrared illuminator array for zero ambient light surveillance, and a color camera that does not need to be enhanced in the infra red spectrum. The system also comprises ambient light level sensing, video signal switching technology and power conversion circuitry. The system combines optimized mono imaging under low or no light conditions with optimized color rendered imaging during high ambient light conditions, with both achieving high quality focus. The dual camera nature of the system is transparent to the user due to the integrated automated control of the system, and allows reduced power consumption, making the system suitable for a wireless, remote, self-contained system that draws power from the ambient environment.

### BACKGROUND OF THE INVENTION

This invention relates to surveillance cameras. It is important for surveillance cameras to be able to record video during night or other low visible light conditions. At night there is little or no visible natural light sufficient to record visible light images, and it is often undesirable or impractical to provide artificial light at night or over great distances and areas in order to enable visible light images to be recorded. Artificial light, particularly if suddenly turned on in response to the sensing of an intrusion, can alert an intruder when the preferred object may be to record him. The continuous lighting of a large area by artificial means can be prohibitively expensive, and may not be possible at all in remote areas. With infrared illumination, it is possible to obtain satisfactory images of a scene at night, and without alerting an intruder.

### DESCRIPTION OF THE PRIOR TECHNOLOGY

In zero ambient light conditions an illuminator must be used to obtain an image with a charge coupled device (CCD) based camera. Generally infrared illumination is used at night because white light can be a nuisance to users and neighbors. Infrared has the added advantage that it can be covert or semi-covert as well. Some manufacturers have enhanced the sensitivity of their CCD sensors to infrared. During low light conditions color information is poor. When using infrared illumination only, there is no color image information, only luminance. Color CCD sensors use three pixels to construct a color from its red, green and blue components. It is therefore less sensitive than a mono CCD when constructing the final image. In addition there is generally color noise from a color camera from its color burst synchronization signal. A mono camera therefore provides better images than a color camera in low light, especially if the mono camera is enhanced in the infrared, whereas in daytime and high light conditions, a color camera provides better images because the color conveys more information and there is enough light to negate the reduction in sensitivity caused by using 3 CCD pixels to create the color.

There have been some attempts in the closed circuit (CCTV) industry to take advantage of the above features of mono and color cameras. One method is to alternatively move a color filter in front of the camera with the filter held in place during high ambient light levels, with the effect of giving the camera a photo-optic response. Although this method achieves good color rendition it suffers from a phenomenon known as focus shift, whereby the camera and lens optical system can only be focused for one permutation and on switching the filter to the other situation, changes the optical path, thus rendering the picture out of focus.

Another method involves using a dual pass filter rather than a purely photo-optic filter. This filter gives a photo-optic response in the visible region of the electromagnetic spectrum but also passes infra red wavelengths from approximately 800 to 1000 nm. This is a compromise because colored objects in view will also be reflecting significant infra red energy from the suns spectrum. This has the effect of distorting the luminance and hue of the colors in the video signal, giving poor color reproduction. This filter is also reducing the maximum sensitivity of the CCD sensor to infra red wavelengths because the infra red, pass section of the filter cannot achieve 100% transmission. This can reduce the range of a useable picture in zero light conditions. The dual pass filter sits over the CCD sensor at all times and is therefore less prone to focus shift, although there is still an element of this due to different degrees of refraction through the lens, due to the refractive index of the lens elements differing with wavelength. This phenomena becomes progressively worse with higher wavelengths and when totally covert operation is required 950 nm illumination would typically be used.

### SUMMARY OF THE INVENTION

This invention uses a dedicated infra red enhanced, CCD camera for night time/low light conditions and a separate economical, lower sensitivity color camera, for high light levels, both with their own dedicated lens system. An optimized night time picture with optimal range can be achieved, as well as superb color rendered images during daytime conditions. Both images will be in focus at all times. The system is further engineered to be transparent to the user as the optimum mode video signal for the ambient light conditions is switched to the output of the unit.

The system comprises:

a) a color camera for observation under bright daytime conditions;

b) a monochrome camera for observation under infrared illumination for dark night-time conditions;

c) an infrared illuminator;

d) a control module for selection of color or monochrome camera operation and of infrared illumination, depending on ambient light conditions.

The color camera has a lens optimized for color with infra-red filtering, and the monochrome camera has a lens optimized for monochrome viewing. The monochrome camera can be supercharged for infrared sensitivity.

The system should have an infrared illuminator, but it could also have built-in visible light illumination or switching means for controlling artificial ambient light. The infra-red illuminator is turned on by the system's control module under mono infra-red mode. The illuminator would preferably give illumination in the range of from 805 to 995 nanometers of electromagnetic radiation.

The color camera and the monochrome camera each have an independent lens having a separate variable focal control via the control module, providing a switch of mode from day to night operation without a focal shift. An auto iris control board that independently controls an iris in each independent lens provides optimizing of the light entering the camera or optimizing the depth of focused field.

The video output signal from the system is switched from mono to color depending on the ambient light levels. Power to the camera that is not being used can be cut, as well as power to the illuminator that is not being used.

The use of the dual cameras together with the control system provides energy savings over using exclusively infrared illumination or exclusively visible light illumination to the level required over a day/night cycle to achieve optimal images by either mode.

The system is thus suited to use in a remote, self-contained surveillance system with a portable power system having a battery, an energy management module, and an ambient energy charger such as a solar panel that converts solar energy to electrical current to charge the battery. A low power detection module would determine what features of the system could be turned on. In the event of low power, intermittent illumination could be used until the system is charged up again. A wireless transmitter can be used for transmission of a video signal to a base. Additionally, the system can comprise a wireless receiver for receiving instructions for the system from the base. A communications board in the system can intelligently capture desired relevant video data at a remote location for transmission to another location and can comprise an internet protocol module by which users can control the surveillance camera at a remote location over the internet, or a satellite based video data transfer module.

For remote service in an outdoor, harsh environment, the system is provided with a housing for the components that is weather-tight to keep moisture out of the electrical and mechanical components, with windows for the camera's view.

In summary, the invention provides superb color observation and imaging under high light conditions, with auto-iris lens, wide dynamic range, and infrared-cut filtering to ensure no infrared on daytime foliage, together with superb monochrome observation and imaging under low or no light conditions. There is no focus shift in switching from day to night scenes. The control module controls photocell sensitivity, camera switching, lens shuttering, and infrared intensity. The invention provides surveillance with the best of both the color and monochrome worlds, suited for remote self-contained use within an all-weather housing such as ¼ inch Lexan. The efficiency of switching to optimal mode enhances, low voltage operation and low power consumption. With LED illuminators, solid state CCD technology and controlled regulated voltage the dual camera surveillance and control system can operate effectively for long periods without servicing or maintenance.

### DESCRIPTION OF THE DRAWINGS

FIG. 1 is a perspective of the system showing the dual camera system in a self-contained housing equipped for wireless transmission of surveillance video from a remote location.

FIG. 2 is a side view of the dual camera system of FIG. 1.

FIG. 3 is a block diagram showing the modules and logic of the dual camera control, and of the power management.

### DETAILED DESCRIPTION

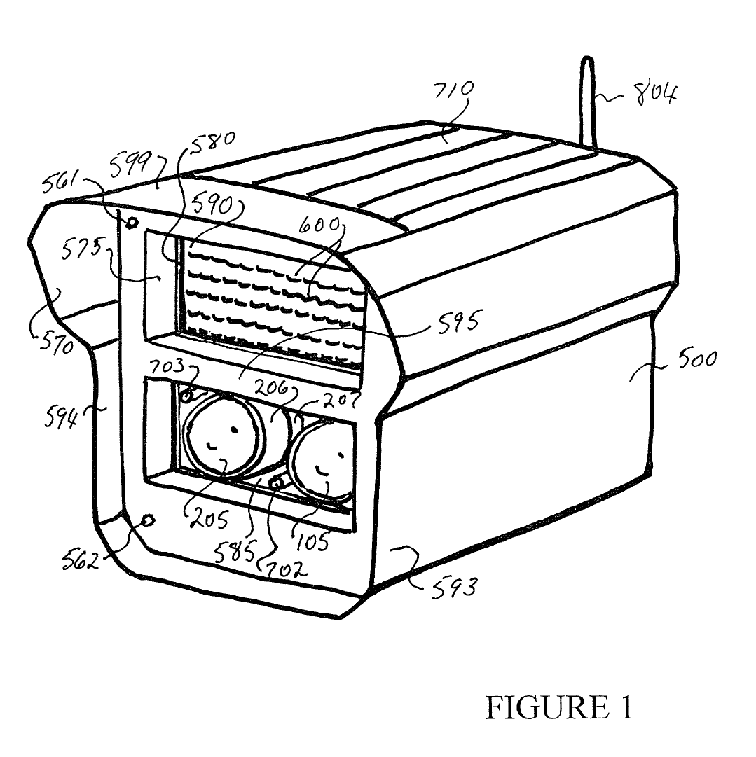

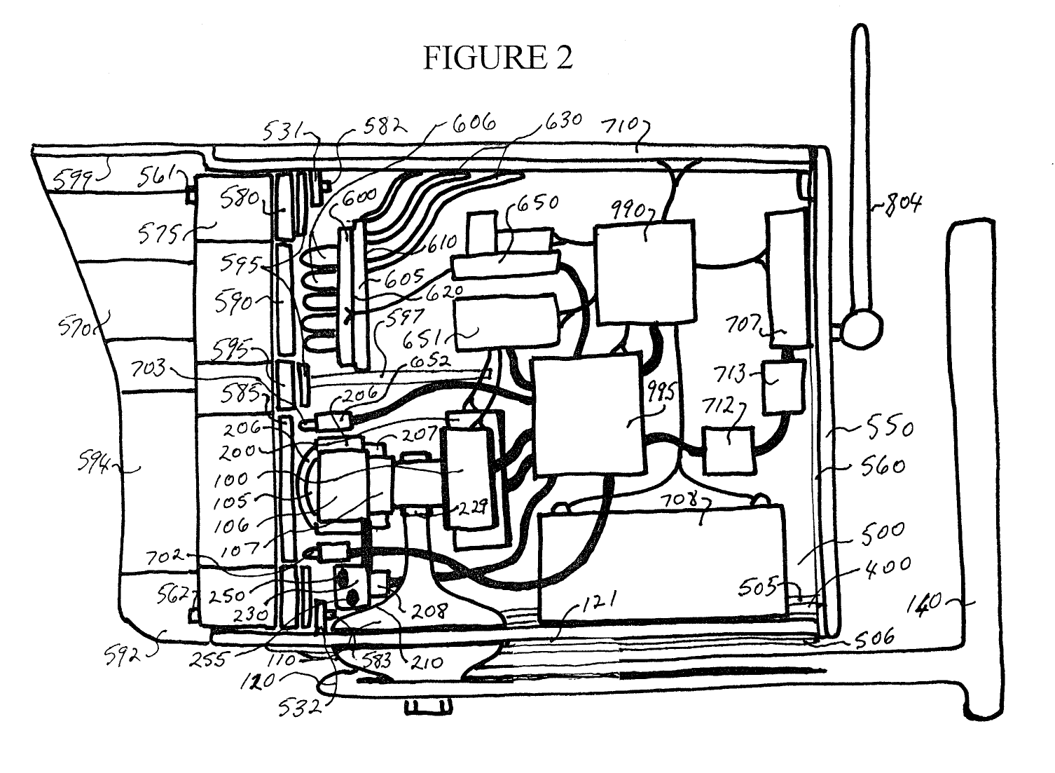

Referring to FIGS. 1 and 2, the unit comprises a monochrome camera 100, which is optimized for wavelengths of light in the infra red region of the electromagnetic spectrum by use of a state of the art charge coupled device. The mono camera 100 comprises a color-filtered (mono) lens 105 that has mechanisms providing adjustments for the field of view 106 and focal plane 107. Rotation of these adjustments in the plane of the camera both frames the target and focuses it. The position of these adjustments can be fixed by twisting these adjustments in the corresponding orthogonal plane. Application of this particular lens is important as it offers variable focal lengths in a small size as opposed to conventional C and CS mount lenses. This in turn helps to produce an overall compact design. The camera unit is mounted on the camera bracket 110. This bracket facilitates mounting of the camera at right angles to the camera slide plate 120. A second camera 200 is chosen that does not need high IR sensitivity and is in fact a color camera only. This camera has a filter over the CCD which converts the spectral response of the CCD to that of the photo-optic curve. This ensures superb color rendition on the final visual display medium of the colors present in the target viewed. This camera also consists of an infrared-filtered (color) lens 205 with mechanism adjustments for field of view 206 and focus 207. Rotation of these adjustments in the plane of the camera both frames and focuses the viewed area. Twisting these adjustments in the orthogonal plane locks the chosen settings. Furthermore this lens consists of an irised aperture to limit the amount of optical power falling on the CCD sensor. The size of the aperture is adjusted by a miniature motor 208, mounted on the side of the lens. The motor is driven from an automatic iris controller board 230 mounted on the front face of the camera mount 210. This controller board has two potentiometers for adjustment of the aperture. One adjustment, on potentiometer 250 sets the gain of the motor and hence aperture. Adjustment of potentiometer 255 sets the sensitivity of control to be based on the peak or average amount of light in view or a combination of peak and average. The cameras 100 and 200 are themselves mounted to the rear of the camera mount 229. The camera mount 229 and bracket facilitates attaching the camera at right angles to the camera slide plate 120, which is in turn adjoined to a wall bracket 140. Both cameras being effectively mounted on a camera slide plate 120 allows suspension of the cameras beyond the extent of the main housing body 500. This plate is designed to slide out along slots as at 121 cut into the main carriage 400. With the cameras extending beyond the main housing body, adjustment can be made in situ of the aforementioned variable focal and autoiris lenses. The cameras can be slid back into position on completion of the adjustments and the slide plate fixed into position. The main carriage 400 consists of a sprung plate which is designed to have just enough tension to be pushed and slid into the main housing 500, gripping the internal fins 505 and 506 of the housing. The main carriage 400 provides mounting for the illuminator matrix 600 a voltage regulator board 650 and a separate voltage regulator board 651 for the cameras 100 and 200. All components can be mounted and tested on the main carriage 400 prior to final assembly into the main housing 500 this allows easy manufacture. The housing of the unit is completed by means of a backplate 550 which is attached to the main housing 500 with a rubber o-ring gasket 560 which seals the back of the unit to dust and water ingress. The front of the unit consists of a front shade 570 and front window assembly. The front window assembly consists of a window plate 580, a bottom acrylic window 585 and a top acrylic window 590. Both windows are chosen to be transparent to infra red as well as visible wavelengths. The window clamp plate 575 is clamped down over the studs 582 and 583 on flanges 531 and 532 and attached with nuts 561 and 562 respectively. This compresses and secures in place a molded gasket 595, sealing the unit against water ingress. The windows are deliberately designed as two separate pieces with partition 595 between so that light from the illuminator array cannot pass from the top half into the bottom half causing undesired optical effects by way of internal reflection of light from the array, within the main housing. Internal reflection is further reduced by means of an opaque optical baffle 597 between the two windows. The front shade 570 comprises an extended top shade 599, side shades 594 and 593 and bottom protector 592 is attached to the window clamp plate 575. The illuminator matrix 600 further consists of a PCB 605 with infra red light emitting diodes 606 in an array. The circuit board is designed to have the largest area of copper possible for each connection. This aids in heat transfer. The PCB is mounted onto the heat sink 610 and a thermally conductive, electrically insulative sheet 620. This sheet 620 is also pliable and conforms to the uneven surface formed on the back of the PCB by the solder joints on the PCB. The heat sink itself can be made so that the fins 630 spring outwards and press firmly against the inside of the main housing 500. The heat generated by the LEDs is then transferred from the large copper pads by the thermal sheet to the heat sink. The heat sink conducts heat to the main housing, which then dissipates heat to the ambient environment. The separate voltage regulator board 651 for the cameras 100 and 200 employs a switch mode power supply using a flyback topology. This allows a wide input alternating current and direct current voltage range, below and above the output voltage. The output is also isolated, eliminating ground loop problems associated with multiple camera systems. This circuit also contains an ambient light level sensing photocell 703 and switching circuit 652, which routes the correct video signal to the output connector 653 dependent on the ambient light level. The LED voltage regulator board 650 controls the drive to the LEDs and allows adjustment of the radiated optical power. A passive infra red sensor array 702 for targeting movement facilitates power conservation in zero activity periods in combination with the ambient light level sensing photocell 703 for power conservation during high ambient light levels. The energy control module 990 mediates charging of the battery 708 by the solar panel 710. These functions are interconnected with the functions controlled by the camera and illumination control module 995. There is an antenna 804 for the radio frequency transceiver 707 for transmitting video and for receiving instructions for the unit connected with the high density digital data storage 712, and internet protocol (IP) module 713 that is addressable via cellphone.

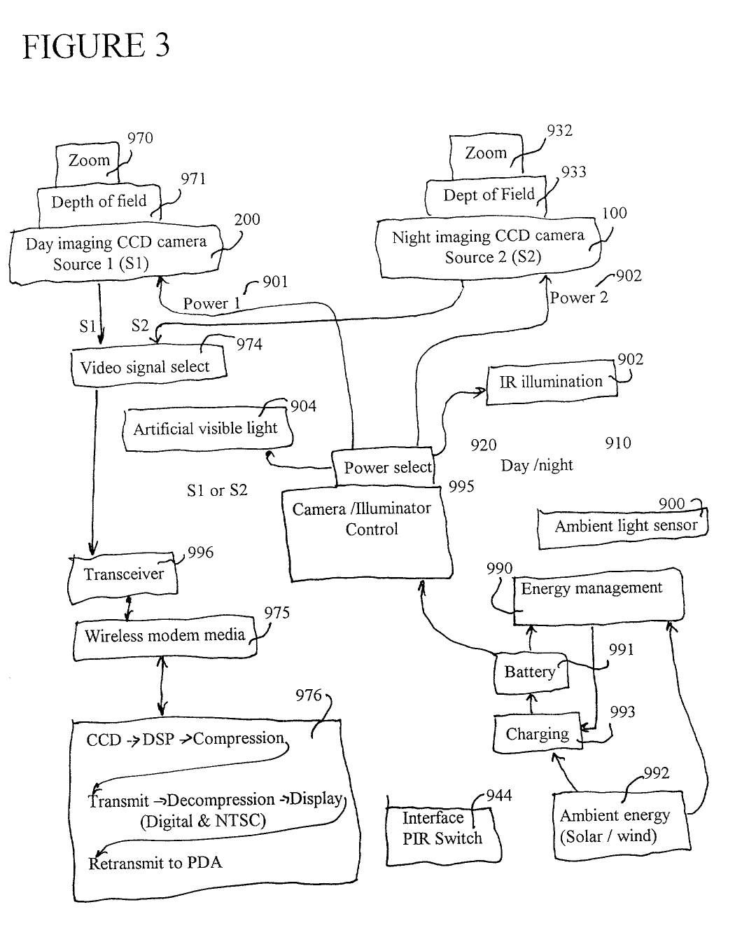

Referring to FIG. 3, the ambient light sensor 900 detecting low light level 910 causes the system to switch to mono camera mode 901, and activates the appropriate degree of infrared illumination 902. When the ambient light sensor 900 detects high light level 920, the system is switched to color camera mode. The infrared illumination 902 is switched off. If available, an appropriate level of artificial visible light 904 can be switched on. The iris control 930 provides the required level of light to be gathered by the camera, and allows optimal focal length 931. The lens control 960 governs mono camera zoom 932 and mono depth of field 933 and color zoom 970 and color depth of field 971 selections depending on interactive choice by the user, or on preset reactions 944 for the system to various types of event within the surveilled field. The motion sensing 950 provides input to the lens control and to the infrared illumination 902 via the camera and illumination control module 995 that decides whether to activate the mono camera 100 or the color camera 200 and selects the video signal output 974 for transmission by wireless media 975. A video and data compression/decompression module 976 can be embedded in the media processes.

The energy management module 990 tracks battery power 991, ambient energy availability 992, and motion sensing. In response to the information provided, the energy management module 990 will switch on the charging circuit 993 when appropriate, and will also give system energy availability information 994 to the camera and illumination control module 995 and the transceiver 996, to reduce the number of video frames per second processed or transmitted in order to conserve power consumption when necessary.

Intermittent infrared illumination and intermittent picture transmission can thus be used instead of constant illumination and continual video transmission to vastly cut the power consumption during periods of low activity in the field of vision of the system, or during periods of low battery power or low availability of ambient re-charging energy.

The self-contained dual camera surveillance and control system is thus suited for use where it is too expensive, inconvenient or impossible to use high voltage power, or where there are no existing sources of electrical power or wires for transmission of the video information to a base. Examples would be surveillance of special events, parades, concerts, fairs, sporting events, public parties, construction zones, wilderness, and hazard zones where it is too dangerous to send people in for visual inspection, but where the highest quality images are desired, the images automatically becoming focused monochrome infrared images under infrared illumination in no light or low ambient light conditions and focused color images when the ambient light becomes sufficient to allow them.

It will be apparent that other shapes of housing can be used for the dual camera self-contained system in place of the housing shown. For example, the housing could be substantially a dome or sphere of ballistic plastic or metal, with a plurality of distortion-free, flat windows for the illuminator and the dual cameras, and with the camera and illuminator rotatably mounted and balanced about a central axis within the dome, that could be then mechanically driven for panning and tilt operation in full 360 degree rotation on two axes. A windmill or heat exchanger could be used in place of or in addition to the solar panel to enable operation remote from electrical grids.

The within-described invention may be embodied in other specific forms and with additional options and accessories without departing from the spirit or essential characteristics thereof. The presently disclosed embodiment is therefore to be considered in all respects as illustrative and not restrictive, the scope of the invention being indicated by the appended claims rather than by the foregoing description, and all changes which come within the meaning and range of equivalence of the claims are therefore intended to be embraced therein.

I claim:

1. A dual camera surveillance and control system comprising:
a) a color camera for observation under bright daytime conditions;
b) a monochrome camera for observation under infrared illumination for dark night-time conditions;
c) an infrared illuminator;
d) a control module for selection of color or monochrome camera operation and of infrared illumination, depending on ambient light conditions.

2. The dual camera surveillance and control system of claim 1, in which the color camera has a lens optimized for color with infra-red filtering.

3. The dual camera surveillance and control system of claim 1, in which the monochrome camera has a lens optimized for monochrome viewing.

4. The dual camera surveillance and control system of claim 1, in which the monochrome camera is supercharged for infrared sensitivity.

5. The dual camera surveillance and control system of claim 1, in which the infra-red illuminator gives illumination in the range of from 805 to 995 nanometers of electromagnetic radiation.

6. The dual camera surveillance and control system of claim 1, in which the color camera and the monochrome camera each has an independent lens having a separate variable focal control via the control module, providing a switch of mode from daylight to infrared night-light operation without a focal shift.

7. The dual camera surveillance and control system of claim 1, comprising an auto iris control board that independently controls an iris in each independent lens.

8. The dual camera surveillance and control system of claim 1, in which a video output signal is switched from mono to color depending on the ambient light levels.

9. The dual camera surveillance and control system of claim 2, in which
a) the monochrome camera has a lens optimized for monochrome viewing;
b) the monochrome camera is supercharged for infrared sensitivity;
c) the infra-red illuminator gives illumination in the range of from 805 to 995 nanometers of electromagnetic radiation;
d) the color camera and the monochrome camera each have an independent lens having a separate variable focal control via the control module, providing a switch of mode from day to night operation without a focal shift.
e) an auto iris control board that independently controls an iris in each independent lens.
f) a video output signal is switched from mono to color depending on the ambient light levels.

10. The dual camera surveillance and control system of claim 1, comprising:
a) a power system having a battery, an energy management module, and an ambient energy charger for the battery;
b) a low power detection module;
c) a wireless transmitter for transmission of video to a base.

11. The dual camera surveillance and control system of claim 10, further comprising a wireless receiver for receiving instructions for the system from the base.

12. The dual camera surveillance and control system of claim 10, in which the energy management module comprises a day/night sensor and a power select switch and in which the ambient energy charger is a solar panel that converts solar energy to electrical current.

13. The dual camera surveillance and control system of claim 10, further comprising a communications board to intelligently capture desired relevant video data at a remote location for transmission to another location.

14. The dual camera surveillance and control system of claim 10, further comprising an internet protocol module by which users can control the surveillance camera at a remote location over the internet.

15. The dual camera surveillance and control system of claim 10, further comprising a satellite based video data transfer module.

16. The dual camera surveillance and control system of claim 10, further comprising a housing for the components that is weather-tight.

17. The dual camera surveillance and control system of claim 10, in which the energy management module comprises a day/night sensor and a power select switch and in which the ambient energy charger is a solar panel that converts solar energy to electrical current, and further comprising:
a) a communications board to intelligently capture desired relevant video data at a remote location for transmission to another location;
b) an internet protocol module by which users can control the surveillance camera at a remote location;
c) a satellite based video data transfer module;
d) a housing for the components that is weather-tight.

18. The dual camera surveillance and control system of claim 9, comprising:
a) a power system having a battery, an energy management module, and an ambient energy charger for the battery, in which the energy management module comprises a day/night sensor, a low power detection module and a power select switch, and in which the ambient energy charger is a solar panel that converts solar energy to electrical current;
b) a wireless transceiver for transmission of video to a base and for receiving instructions for the system from the base;
c) a communications board to intelligently capture desired relevant video data at a remote location for transmission to another location;
d) an internet protocol module by which users can control the surveillance camera at a remote location over the internet;
e) a satellite based video data transfer module;
f) a housing for the components that is weather-tight.

19. The dual camera surveillance and control system of claim 10, further comprising a housing for the components that is a weather-tight, substantially spherical dome having flat windows, the color camera and the mono camera mounted on a central axis within the sphere to allow pan and tilt rotation in full 360 degree rotation on two axes.
